(19) United States
(12) Patent Application Publication
(10) Pub. No.: US 2019/0148808 A1
(43) Pub. Date: May 16, 2019

(54) HOLLOW-WAVEGUIDE-TO-PLANAR-WAVEGUIDE TRANSITION CIRCUIT

(71) Applicant: Mitsubishi Electric Corporation, Tokyo (JP)

(72) Inventors: Hiromasa NAKAJIMA, Tokyo (JP); Akimichi HIROTA, Tokyo (JP); Naofumi YONEDA, Tokyo (JP); Takeshi OSHIMA, Tokyo (JP)

(73) Assignee: Mitsubishi Electric Corporation, Tokyo (JP)

(21) Appl. No.: 16/098,062

(22) PCT Filed: Jul. 5, 2016
(86) PCT No.: PCT/JP2016/069891

§ 371 Date: Oct. 31, 2018

(51) Int. Cl. H01P 5/08; H01P 3/12; H01P 3/08; H01P 1/02

(52) U.S. Cl. CPC H01P 5/08; H01P 1/02; H01P 3/081; H01P 3/121

(57) ABSTRACT

A hollow-waveguide-to-planar-waveguide transition circuit includes: a dielectric substrate; strip conductors formed on a first main surface of the dielectric substrate; a ground conductor formed on a second main surface of the dielectric substrate, facing the strip conductors in the thickness direction; a slot formed in the ground conductor; a coupling conductor formed at a position to be electrically coupled with the strip conductors on the first main surface; and branch conductor lines formed on the first main surface. Each of the branch conductor lines includes a base portion branching from the coupling conductor and a tip portion that is electrically open.

### TECHNICAL FIELD

The present invention relates to a transition circuit for performing conversion of a transmission mode between a hollow waveguide and a planar waveguide such as a microstrip line.

### BACKGROUND ART

In high-frequency transmission lines used in a high-frequency band such as a millimeter wave band or a microwave band, to couple a hollow waveguide and a planar waveguide such as a microstrip line or a coplanar line to each other, transition circuits are widely used for converting a transmission mode between the hollow waveguide and the planar waveguide. For example, Patent Literature 1 (Japanese Patent Application Publication No. 2010-56920) discloses a hollow-waveguide-to-microstrip-line transition circuit for coupling a hollow waveguide with a microstrip line.

The structure of the microstrip line disclosed in Patent Literature 1 includes: a conductor plate and a strip conductor formed on the front surface of a dielectric substrate; a ground conductor provided on the entire back surface of the dielectric substrate; and a plurality of connecting conductors provided in the dielectric substrate and connecting the conductor plate and the ground conductor to each other. The ground conductor is connected to an end portion of the rectangular waveguide, and the ground conductor includes a rectangular slot for electrically coupling with the end portion of the rectangular waveguide. In addition, the conductor plate and the ground conductor form a coplanar line structure. Further, the connecting conductors are arranged around the periphery of a short plane (short-circuit plane) of the end portion of the rectangular waveguide. By providing these connecting conductors, unnecessary radiation from the slot can be suppressed.

### CITATION LIST

### Patent Literature

Patent Literature 1: Japanese Patent Application Publication No. 2010-56920 (for example, FIGS. 1 and 2 and paragraphs [0013] to [0018], and FIGS. 12 and 13 and paragraphs [0043] to [0049])

### SUMMARY OF INVENTION

### Technical Problem

However, with the structure disclosed in Patent Literature 1, there is the disadvantage that, because the connecting conductors are necessary for suppressing unnecessary radiation, the manufacturing process of the hollow-waveguide-to-microstrip-line transition circuit becomes complicated, thereby increasing manufacturing cost.

In view of the foregoing, an object of the present invention is to provide a hollow-waveguide-to-planar-waveguide transition circuit capable of suppressing unnecessary radiation as well as reducing manufacturing cost.

### Solution to Problem

In accordance with an aspect of the present invention, there is provided a hollow-waveguide-to-planar-waveguide transition circuit for transmitting a high-frequency signal. The hollow-waveguide-to-planar-waveguide transition circuit includes: a dielectric substrate having a first main surface and a second main surface which face each other in a thickness direction of the dielectric substrate; one or more strip conductors formed on the first main surface, extending along a first in-plane direction determined in advance; a ground conductor formed on the second main surface to face the one or more strip conductors in the thickness direction; one or more slots formed in the ground conductor and extending in a second in-plane direction different from the first in-plane direction on the second main surface; a coupling conductor formed at a position to be electrically coupled with the one or more strip conductors on the first main surface, and disposed at a position facing the one or more slots in the thickness direction; and one or more branch conductor lines branching from an end portion of the coupling conductor in the second in-plane direction on the first main surface. Each of the branch conductor lines has a base portion branching from the coupling conductor and has a tip portion that is an electrically open.

### Advantageous Effects of Invention

In accordance with the present invention, a hollow-waveguide-to-planar-waveguide transition circuit can be provided which is capable of suppressing unnecessary radiation as well as reducing manufacturing cost.

### BRIEF DESCRIPTION OF DRAWINGS

FIG. 1 is a diagram schematically illustrating a planar structure of a hollow-waveguide-to-planar-waveguide transition circuit of a first embodiment according to the present invention.

FIG. 2 is a schematic cross-sectional view taken along line II-II of a hollow-waveguide-to-planar-waveguide transition circuit 1 illustrated in FIG. 1.

FIG. 3 is a schematic plan view of a conventional hollow-waveguide-to-microstrip-line transition circuit 100.

FIG. 4 is a schematic cross-sectional view taken along line IV-IV of the hollow-waveguide-to-microstrip-line transition circuit 100 illustrated in FIG. 3.

FIG. 5 is a schematic plan view of a hollow-waveguide-to-planar-waveguide transition circuit of a second embodiment according to the present invention.

FIG. 6 is a schematic plan view of a hollow-waveguide-to-planar-waveguide transition circuit of a third embodiment according to the present invention.

FIG. 7 is a schematic plan view of a hollow-waveguide-to-planar-waveguide transition circuit of a fourth embodiment according to the present invention.

FIG. 8 is a schematic cross-sectional view taken along line VIII-VIII of the hollow-waveguide-to-planar-waveguide transition circuit illustrated in FIG. 7.

FIG. 9 is a schematic plan view of a hollow-waveguide-to-planar-waveguide transition circuit of a fifth embodiment according to the present invention.

FIG. 10 is a schematic plan view of a hollow-waveguide-to-planar-waveguide transition circuit of a sixth embodiment according to the present invention.

FIG. 11 is a schematic plan view of a hollow-waveguide-to-planar-waveguide transition circuit of a seventh embodiment according to the present invention.

FIG. 12 is a schematic plan view of a hollow-waveguide-to-planar-waveguide transition circuit of an eighth embodiment according to the present invention.

FIG. 13 is a schematic cross-sectional view taken along line XIII-XIII of the hollow-waveguide-to-planar-waveguide transition circuit illustrated in FIG. 12.

FIG. 14 is a schematic plan view of a hollow-waveguide-to-planar-waveguide transition circuit of a ninth embodiment according to the present invention.

FIG. 15 is a schematic cross-sectional view taken along line XV-XV of the hollow-waveguide-to-planar-waveguide transition circuit illustrated in FIG. 14.

### DESCRIPTION OF EMBODIMENTS

Hereinafter, various embodiments according to the present invention will be described in detail with reference to the drawings. Note that, constituent elements denoted by the same reference numerals throughout the drawings have the same configuration and the same function. In addition, the X, Y, and Z axes illustrated in the drawings are orthogonal to each other.

### First Embodiment

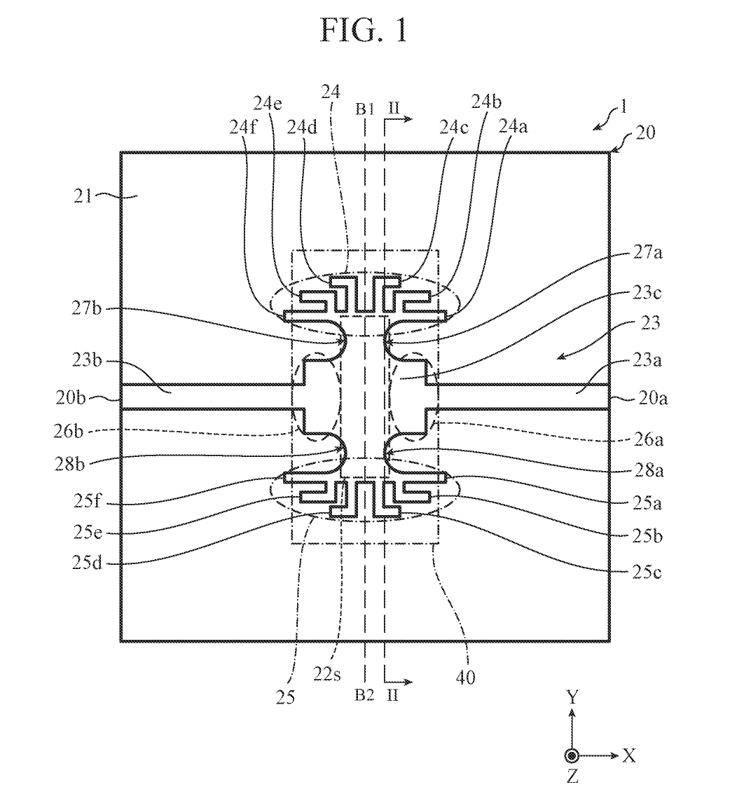

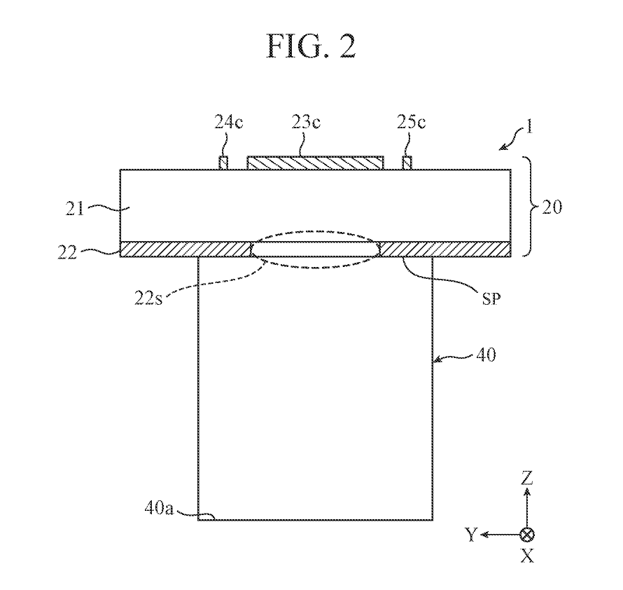

FIG. 1 is a diagram schematically illustrating a planar structure of a hollow-waveguide-to-planar-waveguide transition circuit 1 of a first embodiment according to the present invention. FIG. 2 is a schematic cross-sectional view taken along line II-II of the hollow-waveguide-to-planar-waveguide transition circuit 1 illustrated in FIG. 1. In the cross-sectional view of FIG. 2, open stubs 24b and 25b of a conductor pattern 23 to be described later is not shown.

As illustrated in FIGS. 1 and 2, the hollow-waveguide-to-planar-waveguide transition circuit 1 includes a planar waveguide structure 20 including two input/output ends 20a and 20b to be used for inputting and outputting a high-frequency signal, and a hollow waveguide 40 connected to the planar waveguide structure 20. The hollow-waveguide-to-planar-waveguide transition circuit 1 has a function of mutually performing conversion of a transmission mode (particularly a transmission fundamental mode) of the high-frequency signal between the hollow waveguide 40 and the planar waveguide structure 20, and has an impedance conversion function of mutually performing conversion of a characteristic impedance between the hollow waveguide 40 and the planar waveguide structure 20.

The hollow waveguide 40 is a metallic hollow-core waveguide having a rectangular cross section in a plane orthogonal to the guide axis of the hollow waveguide 40, that is, a rectangular waveguide. Although the tube thickness of the hollow waveguide 40 illustrated in FIG. 2 is omitted, actually there is a tube thickness of several millimeters. The hollow path of the hollow waveguide 40 extends along the guide-axis direction (Z-axis direction). The transmission fundamental mode of the hollow waveguide 40 is, for example, a TE₁₀ mode that is one of TE modes (transverse electric modes). On the other hand, the transmission fundamental mode of the planar waveguide structure 23 is a quasi-transverse electromagnetic mode (quasi TEM mode). The hollow-waveguide-to-planar-waveguide transition circuit 1 can convert the transmission fundamental mode of the high-frequency signal from one of the TE₁₀ mode and the quasi-TEM mode into the other.

The planar waveguide structure 20 includes a dielectric substrate 21 having a rectangular shape such as a square or a rectangle as viewed from the Z-axis direction, and the conductor pattern 23 formed on the front surface (first main surface) of one of two surfaces facing each other of the dielectric substrate 21. Here, the front surface of the dielectric substrate 21 is parallel to the X-Y plane including the X-axis and the Y-axis. The dielectric substrate 21 may include a dielectric material such as glass epoxy, polytetrafluoroethylene (PTFE), or ceramics, for example.

As illustrated in FIG. 1, the conductor pattern 23 includes: two strip conductors 23a and 23b that are linear conductors extending along an in-plane direction determined in advance (X-axis direction) on the front surface of the dielectric substrate 21; a coupling conductor 23c interposed between the strip conductors 23a and 23b and physically connected to the strip conductors 23a and 23b; an open stub group 24 including six open stubs (branch conductor lines) 24a to 24f branching outwardly from the end portion of the coupling conductor 23c on the positive side of the Y-axis direction; and an open stub group 25 including six open stubs (branch conductor lines) 25a to 25f branching outwardly from the end portion of the coupling conductor 23c on the negative side of the Y-axis direction.

In addition, as illustrated in FIG. 2, the planar waveguide structure 20 includes: a ground conductor 22 that is a conductive film formed over the entire back surface (second main surface) of the dielectric substrate 21; a slot 22s that is a coupling window formed in the ground conductor 22; and the hollow waveguide 40 including one end portion connected to a predetermined region (including the slot 22s) of the ground conductor 22. The back surface of the dielectric substrate 21 is parallel to the X-Y plane. As illustrated in FIG. 1, the slot 22s extends along the Y-axis direction different from the extending direction (X-axis direction) of the strip conductors 23a and 23b, and has a rectangular shape whose longitudinal direction is the Y-axis direction.

In addition, the guide-axis direction of the hollow waveguide 40 is parallel to the Z-axis direction. A wall surface forming one end portion of the hollow waveguide 40 on the positive side of the Z-axis direction is physically connected to the ground conductor 22, and forms a short plane (short-circuit plane) SP. The external shape of the hollow waveguide 40 illustrated in FIG. 1 is rectangular, and represents the external shape of the short plane SP. In addition, the other end portion of the hollow waveguide 40 on the negative side of the Z-axis direction forms an input/output end 40a to be used for inputting/outputting a high-frequency signal.

The ground conductor 22 and the conductor pattern 23 can be formed by a plating process, for example. As the constituent material of the conductor pattern 23 and the ground conductor 22, a material may be used, for example, any one of conductive materials such as copper, silver, and gold, or a combination of two or more materials selected from these conductive materials.

As illustrated in FIGS. 1 and 2, the coupling conductor 23c is disposed at a position to face the slot 22s provided on the back surface side of the dielectric substrate 21 in the Z-axis direction (thickness direction of the dielectric substrate 21). In addition, as illustrated in FIG. 1, the coupling conductor 23c includes a substantially rectangular main body portion (hereinafter referred to as a “main coupling portion”) connected to the inner end portions of the strip conductors 23a and 23b. Impedance adjusting portions 26a and 26b are formed near both ends of the main coupling portion in the X-axis direction.

The coupling conductor 23c further includes a coupling portion (hereinafter referred to as a “first coupling end portion”) connected to the base portion of the open stub group 24, and further includes a coupling portion (hereinafter referred to as a “second coupling end portion”) connected to the base portion of the open stub group 25. A width (width in the X-axis direction) Δ1 of the first coupling end portion is narrower than a width (width in the X-axis direction) of the main coupling portion. The width Δ1 is formed by a notched portion 27a recessed in the X-axis negative direction and a notched portion 27b recessed in the X-axis positive direction. Therefore, the notched portions 27a and 27b are formed to be recessed in directions facing each other. On the other hand, a width (width in the X-axis direction) Δ2 of the second coupling end portion is also narrower than the width (width in the X-axis direction) of the main coupling portion. The width Δ2 is formed by a notched portion 28a recessed in the X-axis negative direction and a notched portion 28b recessed in the X-axis positive direction. Therefore, the notched portions 28a and 28b are also formed to be recessed in directions facing each other. Each of the widths Δ1 and Δ2 of the first and second coupling end portions only needs to be formed to be, for example, equal to or more than one eighth (=λ/8) of the wavelength λ corresponding to the center frequency of a predetermined use frequency band of the high-frequency signal.

One of the features of the present embodiment is that the conductor pattern 23 includes the open stub groups 24 and 25 to suppress unnecessary radiation from the slot 22s. One open stub group 24 includes eight open stubs 24a to 24f branching outwardly from the first coupling end portion of the coupling conductor 23c. Among the open stubs 24a to 24f, the open stubs 24a and 24f branch in the X-axis positive direction and the X-axis negative direction, respectively, and each have a linear shape. Among the open stubs 24a to 24f, each of the other open stubs 24b, 24c, 24d, and 24e has a bent shape. Because the tip portions of the open stubs 24a to 24f are electrically insulated, the tip portions are each in an electrically open state.

In addition, the length from the base portion to the tip portion of each of the open stubs 24a to 24f is designed to be equal to a quarter (=λ/4) of the wavelength λ. Therefore, when the hollow-waveguide-to-planar-waveguide transition circuit 1 operates in the use frequency band, the base portion of each of the open stubs of the open stub group 24 is equivalently in an electrical short-circuit state with respect to the center frequency.

The other open stub group 25 also includes eight open stubs 25a to 25f branching outwardly from the second coupling end portion of the coupling conductor 23c. Among the open stubs 25a to 25f, the two open stubs 25a and 25f branch in the X-axis positive direction and the X-axis negative direction, respectively. Among the open stubs 25a to 25f, each of the other open stubs 25b, 25c, 25d, and 25e has a bent shape. Because the tip portions of the open stubs 24a to 24f are electrically insulated, the tip portions are each in an electrically open state. In addition, the length from the base portion to the tip portion of each of the open stubs 24a to 24f is designed to be equal to a quarter (=λ/4) of the wavelength λ. Therefore, when the hollow-waveguide-to-planar-waveguide transition circuit 1 operates in the frequency band to be used, the base portion of each of the open stubs of the open stub group 25 is also equivalently in an electrical short-circuit state with respect to the center frequency.

Next, the operation will be described of the hollow-waveguide-to-planar-waveguide transition circuit 1 of the present embodiment with reference to FIGS. 1 and 2.

In the planar waveguide structure 20 of the present embodiment, a microstrip line is formed by the strip conductors 23a and 23b, the ground conductor 22 facing the strip conductors 23a and 23b, and a dielectric interposed between the ground conductor 22 and the strip conductors 23a and 23b. In addition, a parallel plate line is formed by the coupling conductor 23c, the ground conductor 22 facing the coupling conductor 23c, and a dielectric interposed between the ground conductor 22 and the coupling conductor 23c.

When a high-frequency signal is input to the input/output end 40a of the hollow waveguide 40, the high-frequency signal input excites the slot 22s. Because the longitudinal direction of the slot 22s intersects the longitudinal direction (extending direction) of the strip conductors 23a and 23b, the slot 22s excited and the strip conductors 23a and 23b are magnetically coupled to each other. The high-frequency signal propagates through the parallel plate line to the input/output ends 20a and 20b of the microstrip line and is output. At this time, the slot 22s is excited in the same phase. The strip conductors 23a and 23b are arranged to extend in opposite directions to each other with respect to the slot 22s. Therefore, outputs are made in opposite phases from the input/output ends 20a and 20b. Because the tip portions of the open stubs 24a to 24f and 25a to 25f are each in an electrically open state, the base portions of the open stubs 24a to 24f and 25a to 25f are each in an electrical short-circuit state. Therefore, the high-frequency signal is shielded at the connecting portions of the coupling conductor 23c with the open stub groups 24 and 25, that is, the first and second coupling end portions. As a result, unnecessary radiation can be suppressed.

Conversely, when high-frequency signals in opposite phases are each input to the input/output ends 20a and 20b of the planar waveguide structure 20, the high-frequency signals are synthesized and then output from the input/output end 40a of the hollow waveguide 40.

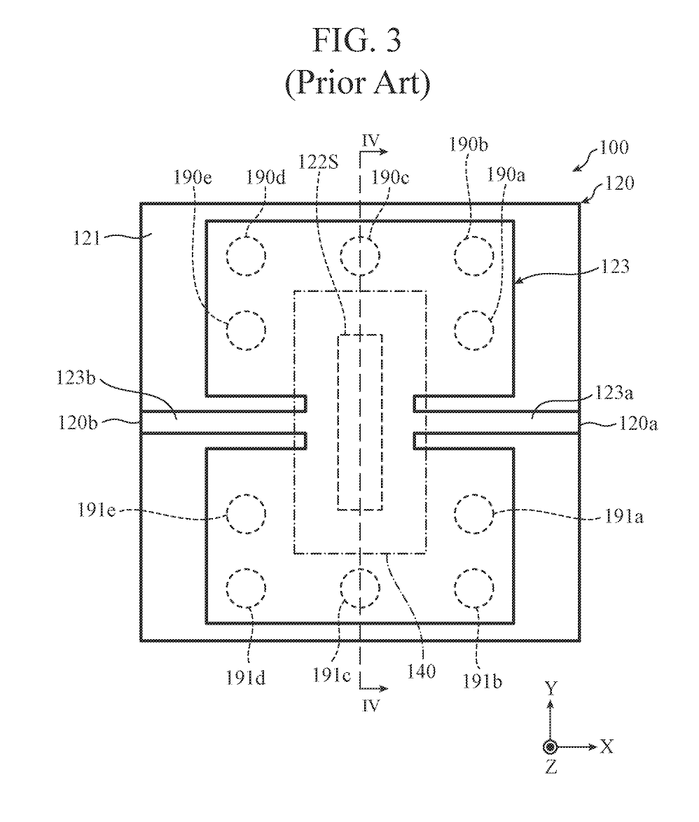

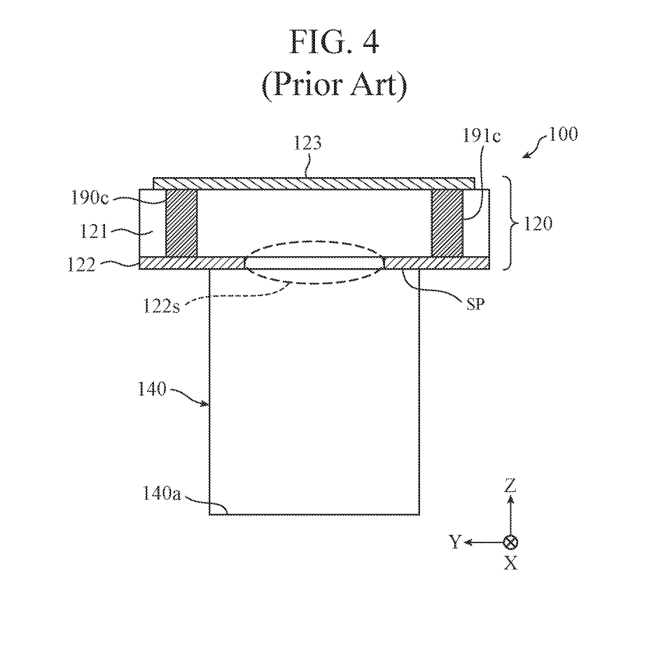

With the hollow-waveguide-to-planar-waveguide transition circuit 1 of the present embodiment, unnecessary radiation can be suppressed without requiring a connecting conductor for connecting the conductor pattern 23 on the front surface of the dielectric substrate 21 and the ground conductor 22 on the back surface of the dielectric substrate 21 to each other. FIG. 3 is a diagram schematically illustrating a planar waveguide structure 120 of a conventional hollow-waveguide-to-microstrip-line transition circuit 100 including that kind of connecting conductors 190a to 190e and 191a to 191e. FIG. 4 is a schematic cross-sectional view taken along line IV-IV of the hollow-waveguide-to-microstrip-line transition circuit 100 illustrated in FIG. 3. A configuration substantially the same as that of the hollow-waveguide-to-microstrip-line transition circuit 100 is disclosed in Patent Literature 1 (Japanese Patent Application Publication No. 2010-56920).

As illustrated in FIG. 3, the planar waveguide structure 120 of the hollow-waveguide-to-microstrip-line transition circuit 100 includes: strip conductors 123a and 123b formed on the front surface of a dielectric substrate 121; a conductor plate 123 formed to connect to the strip conductors 123a and 123b on the front surface; a ground conductor 122 formed on the back surface of the dielectric substrate 121; a rectangular slot 122S formed in the ground conductor 122; and the cylindrical connecting conductors 190a to 190e and 191a to 191e provided in the dielectric substrate 121, and connecting the conductor plate 123 and the ground conductor 122 to each other. As illustrated in FIG. 4, an end portion of a rectangular waveguide 140 is in contact with the ground conductor 122 to form a short plane (short-circuit plane) SP. The connecting conductors 190a to 190e and 191a to 191e are arranged around the periphery of the short plane SP of the rectangular waveguide 140.

When a high-frequency signal is input to an input/output end 140a of the hollow waveguide 140, the high-frequency signal input excites the slot 122S. Because the longitudinal direction of the slot 122S intersects the longitudinal direction of the strip conductors 123a and 123b, the slot 122S excited and the strip conductors 123a and 123b are magnetically coupled to each other. The high-frequency signal is output from input/output ends 120a and 120b of the microstrip line formed by the strip conductors 123a and 123b, and the ground conductor 122, via a parallel plate line formed by the conductor plate 123 and the ground conductor 122. With the hollow-waveguide-to-microstrip-line transition circuit 100, by providing the connecting conductors 190a to 190e and 191a to 191e, unnecessary radiation from the slot 122S can be suppressed.

To provide the connecting conductors 190a to 190e and 191a to 191e, for example, steps are required of a step of forming a through-hole penetrating between the front surface and the back surface in the dielectric substrate 121, and a step of forming a conductor within the through-hole (for example, a plating step and an etching step). However, these steps complicate the manufacturing step of the hollow-waveguide-to-microstrip-line transition circuit 100, and cause an increase in manufacturing cost.

In addition, when the dielectric substrate 121 of the hollow-waveguide-to-microstrip-line transition circuit 100 expands and contracts due to temperature change, tension is applied to the connecting conductors 190a to 190e and 191a to 191e. This possibly causes the connecting conductors 190a to 190e and 191a to 191e to be broken, or possibly deteriorates the characteristic of the hollow-waveguide-to-microstrip-line transition circuit 100.

On the other hand, the hollow-waveguide-to-planar-waveguide transition circuit 1 of the present embodiment can suppress unnecessary radiation without requiring the connecting conductor, so that a low manufacturing cost and a high operation reliability can be achieved as compared with the hollow-waveguide-to-microstrip-line transition circuit 100.

Meanwhile, referring to FIG. 1, the structure of the hollow-waveguide-to-planar-waveguide transition circuit 1 of the present embodiment is designed to have geometric symmetry with respect to a plane (plane parallel to the Y-Z plane) in a line B1-B2 passing through the center of the coupling conductor 23c. For this reason, during operation of the hollow-waveguide-to-planar-waveguide transition circuit 1, an electrical short-circuit state occurs in the plane in the line B1-B2. Provisionally, it is assumed that the open stub groups 24 and 25 do not exist. At this time, when a relative positional deviation occurs between the coupling conductor 23c and the slot 22s due to a manufacturing error, temperature change, aging degradation, or the like, and its geometric symmetry is lost, a surface region where the electrical short-circuit state occurs, that is, an electric wall may be greatly curved. In this case, a deviation in the distribution characteristic occurs between the high-frequency signals propagating to the strip conductors 23a and 23b, thereby deteriorating the transition circuit characteristic.

On the other hand, the hollow-waveguide-to-planar-waveguide transition circuit 1 of the present embodiment includes the open stub groups 24 and 25. As illustrated in FIG. 1, as viewed from the Z-axis direction (thickness direction of the dielectric substrate 21), one open stub group 24 is disposed around the periphery of one end portion of the slot 22s in the longitudinal direction of the slot 22s, and the other open stub group 25 is disposed around the periphery of the other end portion of the slot 22s in the longitudinal direction of the slot 22s. By providing the open stub groups 24 and 25 in this way, even if the positional deviation occurs between the coupling conductor 23c and the slot 22s, multiple electrical short-circuit points are formed between the coupling conductor 23c and the open stub groups 24 and 25, whereby the curvature of the electric wall is suppressed. Therefore, the electrical symmetry of the hollow-waveguide-to-planar-waveguide transition circuit 1 is easily maintained. In addition, because the open stub groups 24 and 25 branch from the first and second coupling end portions of the coupling conductor 23c, even if the manufacturing error, temperature change, aging degradation, or the like occurs, a distribution characteristic difference can be suppressed between the high-frequency signals each propagating to the strip conductors 23a and 23b. Therefore, the hollow-waveguide-to-planar-waveguide transition circuit 1 can be provided having a high operational reliability.

In addition, by narrowing the width of each of the open stubs 24a to 24f and 25a to 25f, the unloaded Q value of each of the open stubs 24a to 24f and 25a to 25f is increased, and the radiation loss can be suppressed. From this viewpoint, the width of each of the open stubs is desirably set to, for example, one tenth (=λ/10) or less of the wavelength λ.

Further, because each of the open stubs 24b to 24e and 25b to 25e in the present embodiment has a bent shape, the hollow-waveguide-to-planar-waveguide transition circuit 1 can be achieved having a small external dimension.

As described above, because the hollow-waveguide-to-planar-waveguide transition circuit 1 according to the present embodiment includes the open stub groups 24 and 25, a low manufacturing cost and a high operation reliability can be achieved while unnecessary radiation is suppressed.

In addition, as illustrated in FIG. 1, the coupling conductor 23c includes the substantially rectangular main coupling portion connected to the inner end portions of the strip conductors 23a and 23b, the first coupling end portion connected to the base portion of the open stub group 24, and the second coupling end portion connected to the base portion of the open stub group 25. As described above, the width (the width in the X-axis direction) Δ1 of the first coupling end portion formed between the notched portions 27a and 27b is narrower than the width (width in the X-axis direction) of the main coupling portion. In addition, the width (width in the X-axis direction) Δ2 of the second coupling end portion formed between the notched portions 28a and 28b is also narrower than the width (width in the X-axis direction) of the main coupling portion. For this reason, an electrical short-circuit state can be produced stably.

### Second Embodiment

The first embodiment has the structure in which the strip conductors 23a and 23b and the coupling conductor 23c are physically connected to each other in the impedance adjusting portions 26a and 26b, although no limitation thereto is intended. The first embodiment may be modified to include a structure including strip conductors and a coupling conductor physically separated from each other in the impedance adjusting portions. Hereinafter, second and third embodiments will be described each including such a structure.

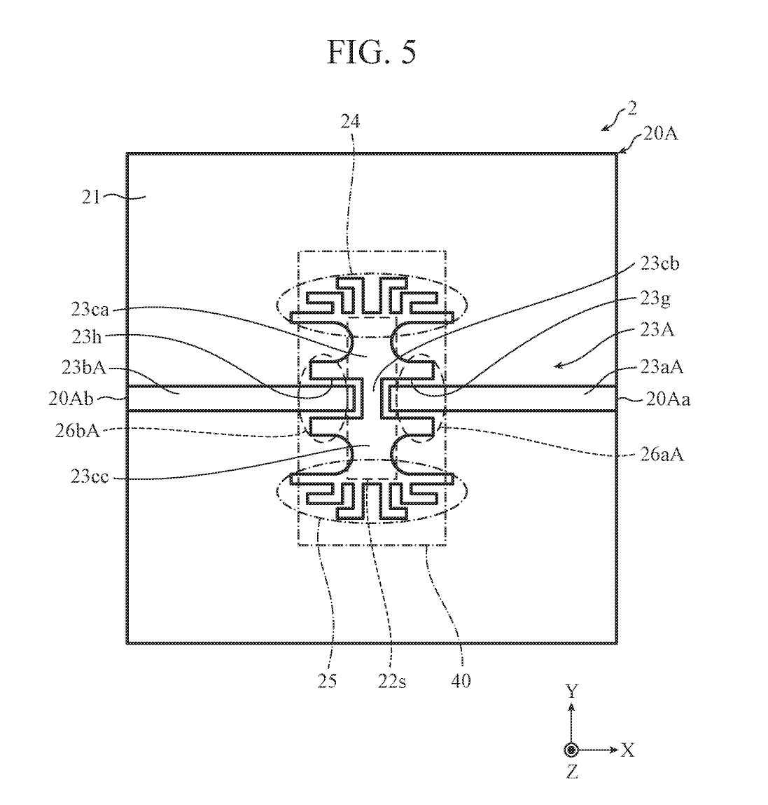

FIG. 5 is a diagram schematically illustrating a planar structure of a hollow-waveguide-to-planar-waveguide transition circuit 2 of the second embodiment that is a first modification of the first embodiment. The configuration of the hollow-waveguide-to-planar-waveguide transition circuit 2 is the same as that of the hollow-waveguide-to-planar-waveguide transition circuit 1 of the first embodiment except that a conductor pattern 23A of FIG. 5 is included instead of the conductor pattern 23 of FIG. 1. In addition, the step of forming the conductor pattern 23A is the same as the step of forming the conductor pattern 23.

The hollow-waveguide-to-planar-waveguide transition circuit 2 of the present embodiment includes a planar waveguide structure 20A including input/output ends 20Aa and 20Ab as illustrated in FIG. 5, and the planar waveguide structure 20A includes the conductor pattern 23A on the front surface of the dielectric substrate 21. The conductor pattern 23A includes: strip conductors 23aA and 23bA physically separated from each other in the X-axis direction; the open stub groups 24 and 25; a first coupling conductor 23ca connected to the open stub group 24; a second coupling conductor 23cc connected to the open stub group 25; and a connecting portion 23cb connecting the first coupling conductor 23ca and the second coupling conductor 23cc to each other. The connecting portion 23cb is disposed to be interposed between the strip conductors 23aA and 23bB, and to be physically separated from the strip conductors 23aA and 23bB. The first coupling conductor 23ca has the same pattern shape as that of the first coupling end portion of the coupling conductor 23c of the first embodiment illustrated in FIG. 1, and the second coupling conductor 23cc has the same pattern shape as that of the second coupling end portion of the coupling conductor 23c of the first embodiment illustrated in FIG. 1.

In addition, the first coupling conductor 23ca, the connecting portion 23cb, and the second coupling conductor 23cc form a recessed portion 23g recessed in the X-axis negative direction and a recessed portion 23h recessed in the X-axis positive direction. The inner end portion of one strip conductor 23aA is surrounded by the recessed portion 23g, and the inner end portion of the other strip conductor 23bA is surrounded by the recessed portion 23h. The coupling conductor of the present embodiment is configured by the first coupling conductor 23ca, the connecting portion 23cb, and the second coupling conductor 23cc as described above. The structure of the coupling conductor of the present embodiment is substantially the same as a structure in which the recessed portions 23g and 23h are formed by processing the coupling conductor 23c of the first embodiment. As illustrated in FIG. 5, impedance adjusting portions 26aA and 26bA of the present embodiment are respectively formed near the recessed portions 23g and 23h.

Because the hollow-waveguide-to-planar-waveguide transition circuit 2 of the present embodiment also includes the open stub groups 24 and 25 as in the first embodiment, a low manufacturing cost and a high operation reliability can be achieved while unnecessary radiation is suppressed.

### Third Embodiment

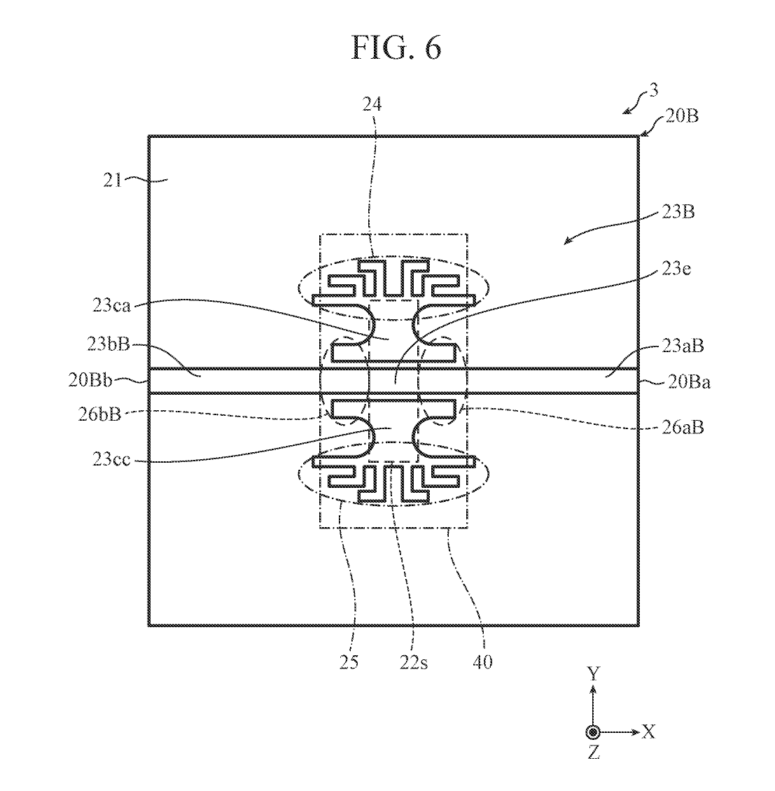

FIG. 6 is a diagram schematically illustrating a planar structure of a hollow-waveguide-to-planar-waveguide transition circuit 3 of the third embodiment that is a second modification of the first embodiment. The configuration of the hollow-waveguide-to-planar-waveguide transition circuit 3 is the same as that of the hollow-waveguide-to-planar-waveguide transition circuit 1 of the first embodiment except that a conductor pattern 23B of FIG. 6 is included instead of the conductor pattern 23 of FIG. 1. In addition, the step of forming the conductor pattern 23B is the same as the step of forming the conductor pattern 23.

The hollow-waveguide-to-planar-waveguide transition circuit 3 of the present embodiment includes a planar waveguide structure 20B including input/output ends 20Ba and 20Bb as illustrated in FIG. 6, and the planar waveguide structure 20B includes the conductor pattern 23B on the front surface of the dielectric substrate 21. The conductor pattern 23B includes: strip conductors 23aB and 23bB connected to each other via a connecting portion 23e in the X-axis direction; the open stub groups 24 and 25; the first coupling conductor 23ca connected to the open stub group 24; and the second coupling conductor 23cc connected to the open stub group 25. The first coupling conductor 23ca and the second coupling conductor 23cc are physically separated from each other, and the strip conductors 23aB and 23bB and the connecting portion 23e are arranged in a region between the first coupling conductor 23ca and the second coupling conductor 23cc. As in the case of the second embodiment, the first coupling conductor 23ca has the same pattern shape as that of the first coupling end portion of the coupling conductor 23c of the first embodiment illustrated in FIG. 1, and the second coupling conductor 23cc has the same pattern shape as that of the second coupling end portion of the coupling conductor 23c of the first embodiment illustrated in FIG. 1. The coupling conductor of the present embodiment is configured by the first coupling conductor 23ca and the second coupling conductor 23cc as described above. As illustrated in FIG. 6, impedance adjusting portions 26aB and 26bB of the present embodiment are respectively formed near both ends of the first coupling conductor 23ca and the second coupling conductor 23cc in the X-axis direction.

Because the hollow-waveguide-to-planar-waveguide transition circuit 3 of the present embodiment also includes the open stub groups 24 and 25 as in the first embodiment, a low manufacturing cost and a high operation reliability can be achieved while unnecessary radiation is suppressed.

### Fourth Embodiment

Each of the hollow-waveguide-to-planar-waveguide transition circuits 1 to 3 of the first to third embodiments described above has a single slot 22s, although no limitation thereto is intended. The first to third embodiments may be modified to have two or more slots. Hereinafter, fourth and fifth embodiments will be described each having a plurality of slots.

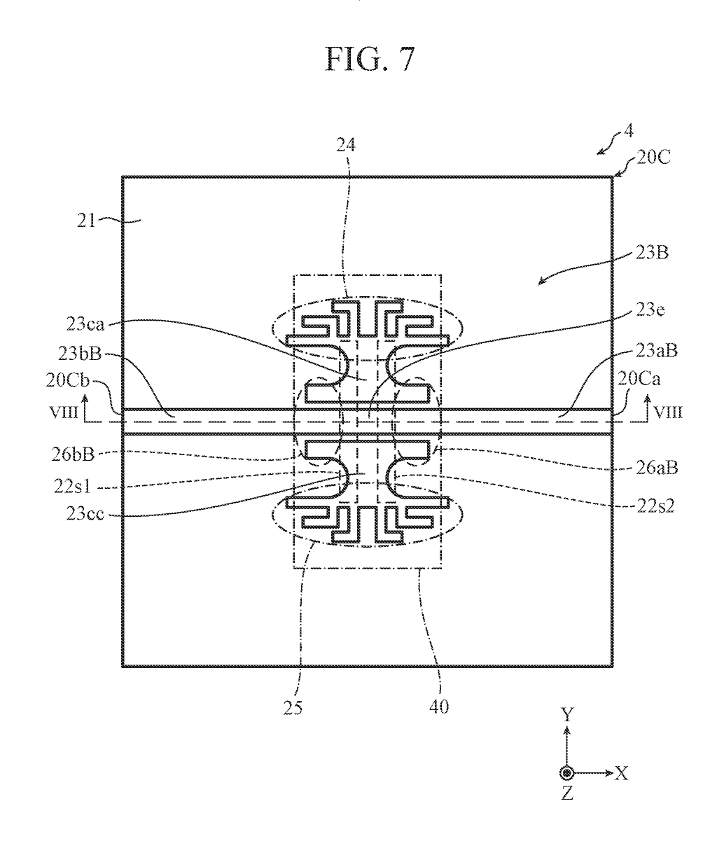

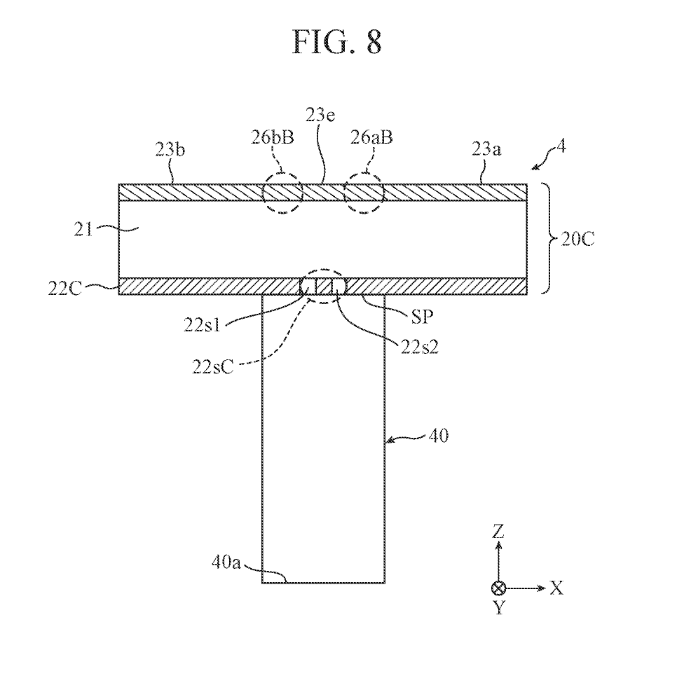

FIG. 7 is a diagram schematically illustrating a planar structure of a hollow-waveguide-to-planar-waveguide transition circuit 4 of the fourth embodiment that is a modification of the third embodiment (FIG. 6). In addition, FIG. 8 is a schematic cross-sectional view taken along line VIII-VIII of the hollow-waveguide-to-planar-waveguide transition circuit 4 illustrated in FIG. 7. The configuration of the hollow-waveguide-to-planar-waveguide transition circuit 4 is the same as that of the hollow-waveguide-to-planar-waveguide transition circuit 3 of the third embodiment except that two slots 22s1 and 22s2 are included illustrated in FIG. 8.

The hollow-waveguide-to-planar-waveguide transition circuit 4 of the present embodiment includes a planar waveguide structure 20C including input/output ends 20Ca and 20Cb as illustrated in FIG. 7, and the planar waveguide structure 20C includes the conductor pattern 23B on the front surface of the dielectric substrate 21. As illustrated in FIG. 8, a ground conductor 22C is provided on the back surface of the dielectric substrate 21. In the ground conductor 22C, a slot group 22sC is formed including the rectangular slots 22s1 and 22s2 extending in the Y-axis direction. The strip conductors 23aB and 23bB are arranged to extend in opposite directions to each other (X-axis positive direction and X-axis negative direction) with respect to the slot group 22sC. Because the hollow-waveguide-to-planar-waveguide transition circuit 4 of the present embodiment also includes the open stub groups 24 and 25 as in the first embodiment, a low manufacturing cost and a high operation reliability can be achieved while unnecessary radiation is suppressed.

### Fifth Embodiment

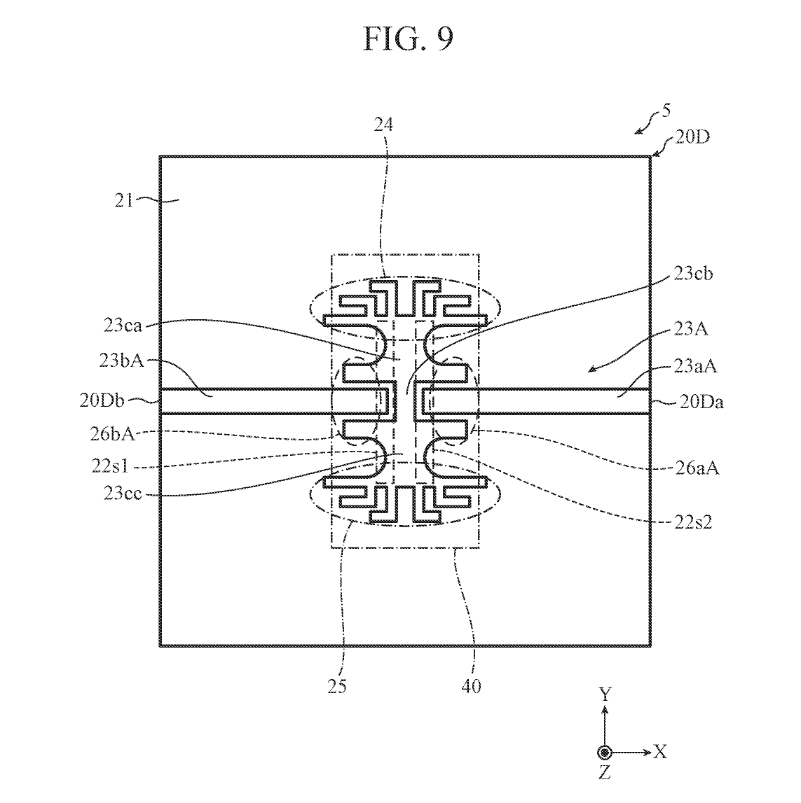

FIG. 9 is a diagram schematically illustrating a planar structure of the hollow-waveguide-to-planar-waveguide transition circuit 5 of the fifth embodiment that is a modification of the second embodiment (FIG. 5). The configuration of the hollow-waveguide-to-planar-waveguide transition circuit 5 is the same as that of the hollow-waveguide-to-planar-waveguide transition circuit 2 of the second embodiment except that the two slots 22s1 and 22s2 illustrated in FIG. 9 are included as in the fourth embodiment.

The hollow-waveguide-to-planar-waveguide transition circuit 5 of the present embodiment includes a planar waveguide structure 20D including input/output ends 20Da and 20Db as illustrated in FIG. 9, and the planar waveguide structure 20D includes the conductor pattern 23A on the front surface of the dielectric substrate 21. Because the hollow-waveguide-to-planar-waveguide transition circuit 5 of the present embodiment also includes the open stub groups 24 and 25 as in the first embodiment, a low manufacturing cost and a high operation reliability can be achieved while unnecessary radiation is suppressed.

### Sixth Embodiment

As illustrated in FIG. 1, the coupling conductor 23c of the first embodiment includes the substantially rectangular main coupling portion connected to the inner end portions of the strip conductors 23a and 23b, and the impedance adjusting portions 26a and 26b are formed near both ends of the main coupling portion in the X-axis direction. The external shape of the main coupling portion of the coupling conductor 23c is substantially rectangular, although no limitation thereto is intended. The conductor pattern 23 of the first embodiment may be modified to include a coupling conductor having a stair shape or a tapered shape in the impedance adjusting portion. In the following, descriptions will be made of a sixth embodiment that includes a conductor pattern including a coupling conductor having a stair shape in the impedance adjusting portion, and a seventh embodiment that includes a conductor pattern including a coupling conductor having a tapered shape in the impedance adjusting portion.

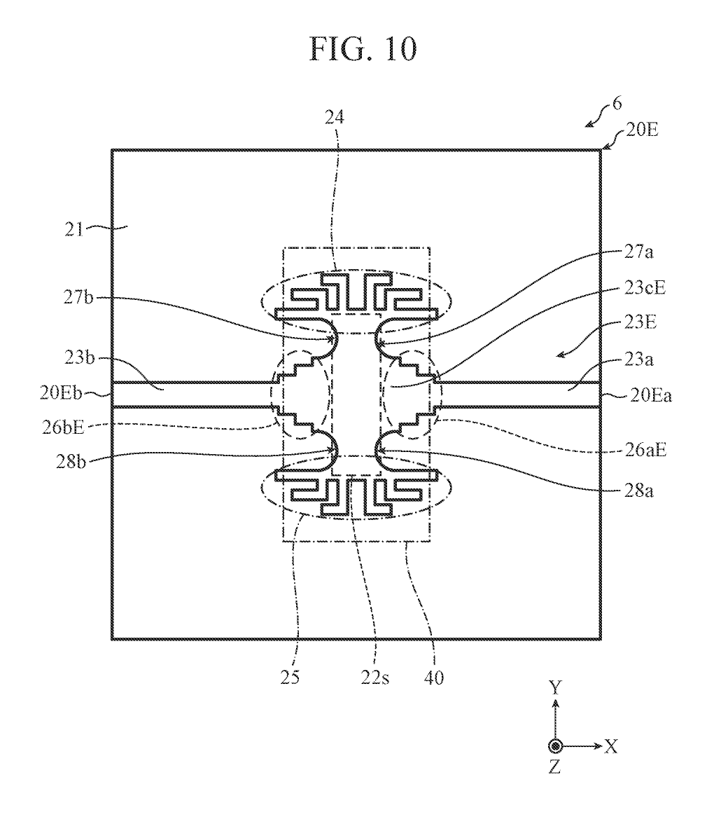

FIG. 10 is a diagram schematically illustrating a planar structure of a hollow-waveguide-to-planar-waveguide transition circuit 6 of the sixth embodiment that is a third modification of the first embodiment. The configuration of the hollow-waveguide-to-planar-waveguide transition circuit 6 is the same as that of the hollow-waveguide-to-planar-waveguide transition circuit 1 of the first embodiment except that a conductor pattern 23E of FIG. 10 is included instead of the conductor pattern 23 of FIG. 1. In addition, the step of forming the conductor pattern 23E is the same as the step of forming the conductor pattern 23.

The hollow-waveguide-to-planar-waveguide transition circuit 6 of the present embodiment includes a planar waveguide structure 20E including input/output ends 20Ea and 20Eb as illustrated in FIG. 10, and the planar waveguide structure 20E includes the conductor pattern 23E on the front surface of the dielectric substrate 21. The shape of the conductor pattern 23E is the same as the shape of the conductor pattern 23 of the first embodiment except that a coupling conductor 23cE of FIG. 10 is included instead of the coupling conductor 23c of FIG. 1.

Similarly to the coupling conductor 23c, the coupling conductor 23cE of the present embodiment is disposed at a position to face the slot 22s provided on the back surface side of the dielectric substrate 21 in the Z-axis direction (thickness direction of the dielectric substrate 21). In addition, as illustrated in FIG. 10, the coupling conductor 23cE includes a main coupling portion connected to the inner end portions of the strip conductors 23a and 23b. Impedance adjusting portions 26aE and 26bE are formed near both ends of the main coupling portion in the X-axis direction. In addition, as in the first embodiment, the coupling conductor 23cE includes the first coupling end portion connected to the base portion of the open stub group 24, and the second coupling end portion connected to the base portion of the open stub group 25.

The coupling conductor 23cE of the present embodiment has a stair shape in which the width of the main coupling portion in the X-axis direction changes in a manner that stepwise increases the width as the location of the width changes from the first coupling end portion (portion connected to the base portion of the open stub group 24) toward the strip conductors 23a and 23b in the impedance adjusting portions 26aE and 26bE. Further, the coupling conductor 23cE has a stair shape in which the width of the main coupling portion in the X-axis direction changes in a manner that stepwise increases the width as the location of the width changes from the second coupling end portion (portion connected to the base portion of the open stub group 25) toward the strip conductors 23a and 23b in the impedance adjusting portions 26aE and 26bE.

Because the hollow-waveguide-to-planar-waveguide transition circuit 6 of the present embodiment also includes the open stub groups 24 and 25 as in the first embodiment, a low manufacturing cost and a high operation reliability can be achieved while unnecessary radiation is suppressed. In addition, because the coupling conductor 23cE of the present embodiment has the stair shape, a propagation direction of the high-frequency signal incident from the hollow waveguide 40 can be continuously and smoothly changed, so that a traveling direction of the high-frequency signal can be directed to the strip conductors 23a and 23b sides. As a result, a high-frequency signal can be efficiently propagated to the strip conductors 23a and 23b while unnecessary radiation is suppressed.

### Seventh Embodiment

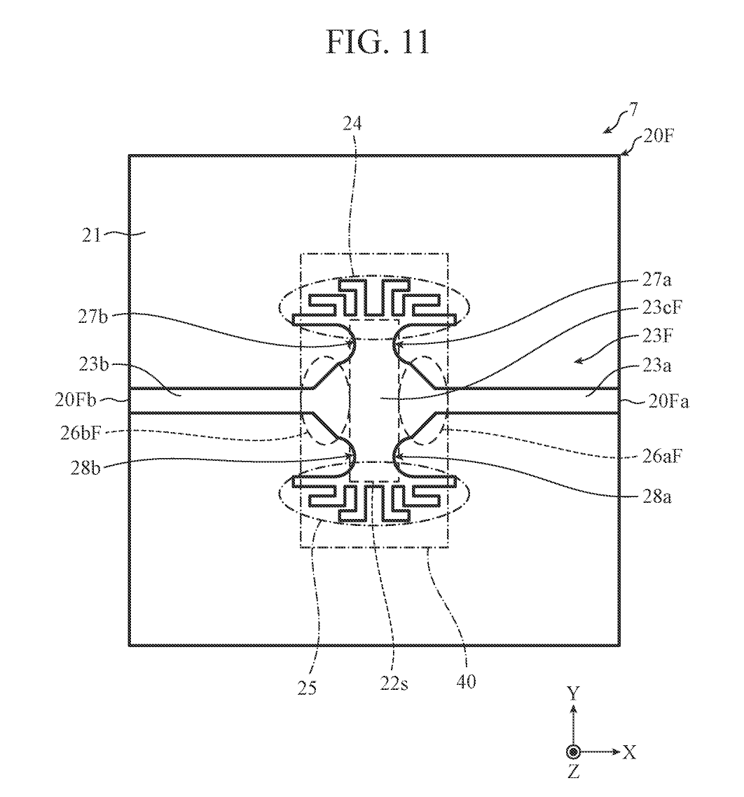

FIG. 11 is a diagram schematically illustrating a planar structure of a hollow-waveguide-to-planar-waveguide transition circuit 7 of the seventh embodiment that is a fourth modification of the first embodiment. The configuration of the hollow-waveguide-to-planar-waveguide transition circuit 7 is the same as that of the hollow-waveguide-to-planar-waveguide transition circuit 1 of the first embodiment except that a conductor pattern 23F of FIG. 11 is included instead of the conductor pattern 23 of FIG. 1. In addition, the step of forming the conductor pattern 23F is the same as the step of forming the conductor pattern 23.

The hollow-waveguide-to-planar-waveguide transition circuit 7 of the present embodiment includes a planar waveguide structure 20F including input/output ends 20Fa and 20Fb as illustrated in FIG. 11, and the planar waveguide structure 20F includes the conductor pattern 23F on the front surface of the dielectric substrate 21. The shape of the conductor pattern 23F is the same as the shape of the conductor pattern 23 of the first embodiment except that a coupling conductor 23cF of FIG. 11 is included instead of the coupling conductor 23c of FIG. 1.

Similarly to the coupling conductor 23c, the coupling conductor 23cF of the present embodiment is disposed at a position to face the slot 22s provided on the back surface side of the dielectric substrate 21 in the Z-axis direction (thickness direction of the dielectric substrate 21). In addition, as illustrated in FIG. 11, the coupling conductor 23cF includes a main coupling portion connected to the inner end portions of the strip conductors 23a and 23b. Impedance adjusting portions 26aF and 26bF are formed near both ends of the main coupling portion in the X-axis direction. In addition, as in the first embodiment, the coupling conductor 23cF includes the first coupling end portion connected to the base portion of the open stub group 24, and the second coupling end portion connected to the base portion of the open stub group 25.

The coupling conductor 23cF of the present embodiment has a tapered shape in which the width of the main coupling portion in the X-axis direction changes in a manner that increases the width as the location of the width changes from the first coupling end portion (portion connected to the base portion of the open stub group 24) toward the strip conductors 23a and 23b in the impedance adjusting portions 26aF and 26bF. Further, the coupling conductor 23cF has a tapered shape in which the width of the main coupling portion in the X-axis direction changes in a manner that increases the width as the location of the width changes from the second coupling end portion (portion connected to the base portion of the open stub group 25) toward the strip conductors 23a and 23b in the impedance adjusting portions 26aF and 26bF.

Because the hollow-waveguide-to-planar-waveguide transition circuit 7 of the present embodiment also includes the open stub groups 24 and 25 as in the first embodiment, a low manufacturing cost and a high operation reliability can be achieved while unnecessary radiation is suppressed. In addition, because the coupling conductor 23cF of the present embodiment has the tapered shape, a propagation direction of the high-frequency signal incident from the hollow waveguide 40 can be continuously and smoothly changed, so that a traveling direction of the high-frequency signal can be directed to the strip conductors 23a and 23b sides. As a result, a high-frequency signal can be efficiently propagated to the strip conductors 23a and 23b while unnecessary radiation is suppressed.

### Eighth Embodiment

In the planar waveguide structure 20 of the first embodiment, as illustrated in FIG. 1, the slot 22s formed on the back surface of the dielectric substrate 21 has a rectangular shape, although no limitation thereto is intended. The shape of the slot 22s may be modified such that the widths (widths in the X-axis direction) of both end portions in the longitudinal direction of the slot 22s of the first to third, sixth, and seventh embodiments described above are each greater than the width (width in the X-axis direction) of the midportion of the slot 22s. In addition, the shapes of the slots 22s1 and 22s2 may be modified such that the widths (widths in the X-axis direction) of both end portions in the longitudinal direction of each of the slots 22s1 and 22s2 of the fourth and fifth embodiments are each greater than the width (width in the X-axis direction) of the midportion of a corresponding one of the slots 22s1 and 22s2.

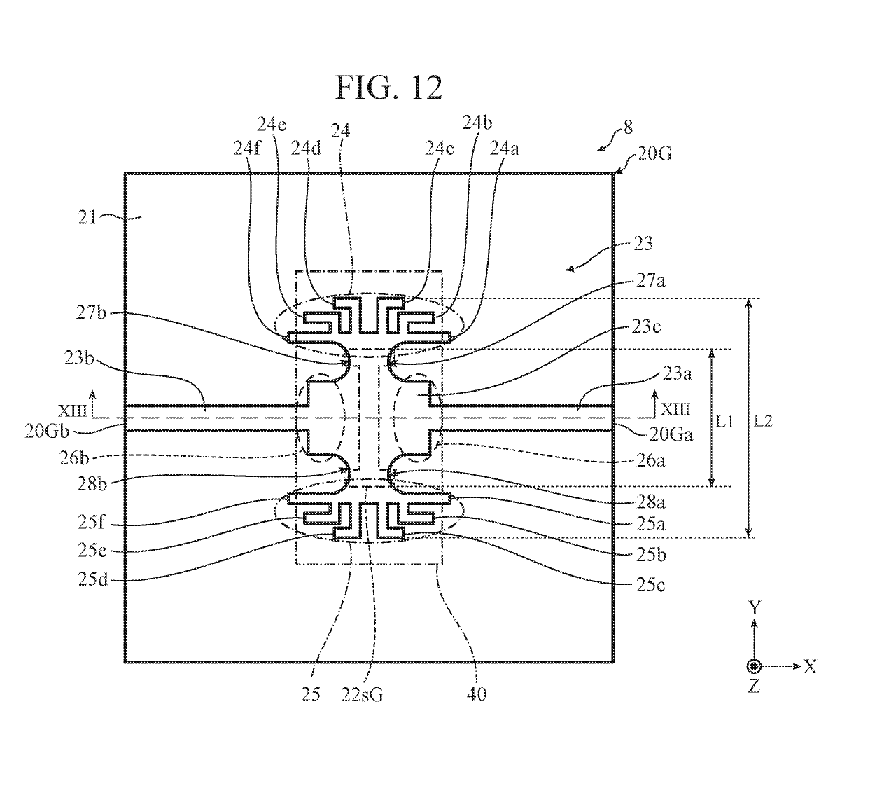

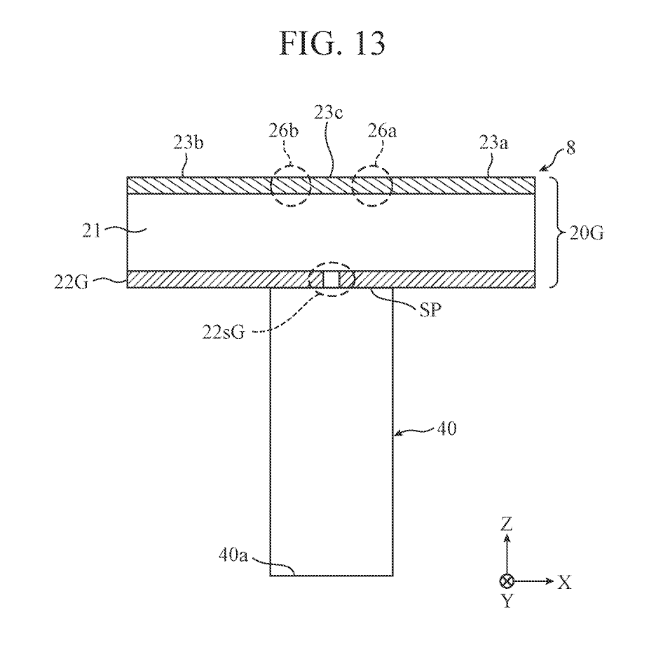

FIG. 12 is a diagram schematically illustrating a planar structure of a hollow-waveguide-to-planar-waveguide transition circuit 8 of an eighth embodiment that is a fifth modification of the first embodiment. FIG. 13 is a schematic cross-sectional view taken along line XIII-XIII of the hollow-waveguide-to-planar-waveguide transition circuit 8 illustrated in FIG. 12. The configuration of the hollow-waveguide-to-planar-waveguide transition circuit 8 is the same as that of the hollow-waveguide-to-planar-waveguide transition circuit 1 of the first embodiment except that a slot 22sG illustrated in FIGS. 12 and 13 is included instead of the slot 22s having the shape illustrated in FIGS. 1 and 2.

The hollow-waveguide-to-planar-waveguide transition circuit 8 of the present embodiment includes a planar waveguide structure 20G including input/output ends 20Ga and 20Gb as illustrated in FIG. 12, and the planar waveguide structure 20G includes the conductor pattern 23 on the front surface of the dielectric substrate 21, as in the first embodiment. In addition, in the planar waveguide structure 20G, as illustrated in FIG. 13, a ground conductor 22G is provided on the back surface of the dielectric substrate 21. The rectangular slot 22sG extending in the Y-axis direction is formed in the ground conductor 22G. As illustrated in FIG. 12, the widths of both end portions of the slot 22sG in the longitudinal direction are each greater than the width of the midportion of the slot 22sG.

By increasing the widths of the both end portions of the slot 22sG in this way, a length L1 in the longitudinal direction (Y-axis direction) of the slot 22sG can be reduced (shortened) while the technical effect similar to that of the first embodiment is maintained. As a result, a length L2 of the conductor pattern 23 in the Y-axis direction can be reduced (shortened). Therefore, downsizing of the hollow-waveguide-to-planar-waveguide transition circuit 8 can be achieved.

Note that, the slot 22sG as described above can also be applied to a ninth embodiment described below.

### Ninth Embodiment

In the first to eighth embodiments, the number of input/output ends of each of the planar waveguide structures 20, and 20A to 20G is two, although no limitation thereto is intended. The planar waveguide structure of each of the above embodiments may be modified to include four or more input/output ends.

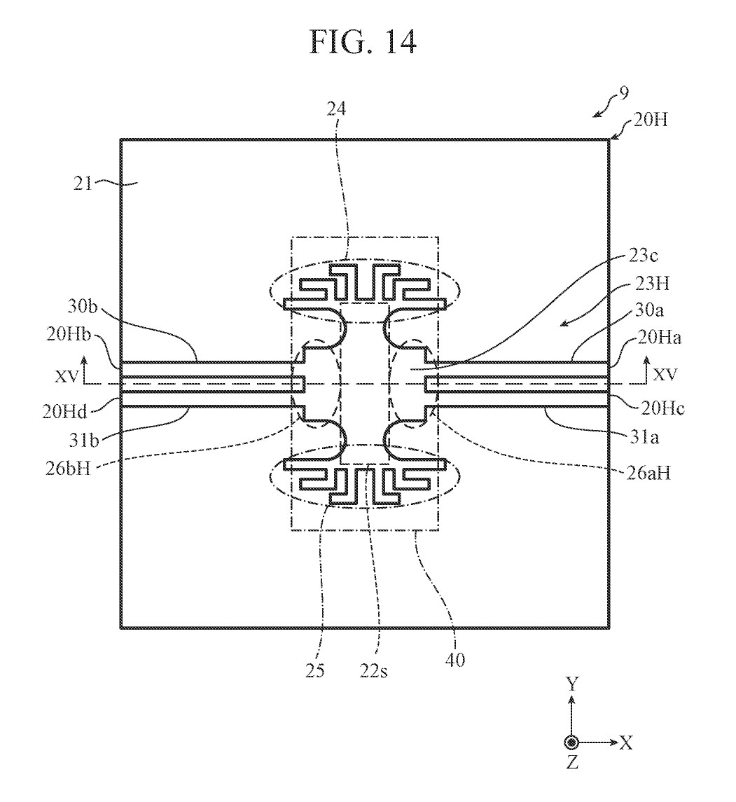

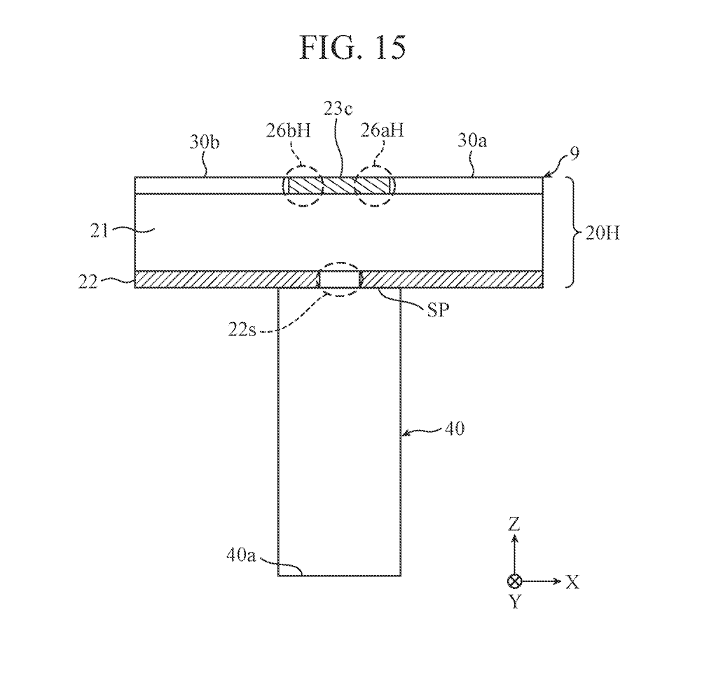

FIG. 14 is a diagram schematically illustrating a planar structure of a hollow-waveguide-to-planar-waveguide transition circuit 9 of the ninth embodiment that is a sixth modification of the first embodiment. FIG. 15 is a schematic cross-sectional view taken along line XV-XV of the hollow-waveguide-to-planar-waveguide transition circuit 9 illustrated in FIG. 14. The configuration of the hollow-waveguide-to-planar-waveguide transition circuit 9 is the same as that of the hollow-waveguide-to-planar-waveguide transition circuit 1 of the first embodiment except that a conductor pattern 23H of FIG. 14 is included instead of the conductor pattern 23 of FIG. 1. In addition, the step of forming the conductor pattern 23H is the same as the step of forming the conductor pattern 23.

The hollow-waveguide-to-planar-waveguide transition circuit 9 of the present embodiment includes a planar waveguide structure 20H including four input/output ends 20Ha, 20Hb, 20Hc, and 20Hd as illustrated in FIG. 14, and the planar waveguide structure 20H includes the conductor pattern 23H on the front surface of the dielectric substrate 21. The conductor pattern 23H includes the coupling conductor 23c and the open stub groups 24 and 25 as in the first embodiment. The conductor pattern 23H further includes strip conductors 30a, 30b, 31a, and 31b that are linear conductors extending in the X-axis direction. All of the strip conductors 30a, 30b, 31a and 31b are connected to the coupling conductor 23c.

In addition, the coupling conductor 23c of the present embodiment includes a substantially rectangular main coupling portion connected to the inner end portions of the strip conductors 30a, 30b, 31a, and 31b, and impedance adjusting portions 26aH and 26bH are formed near both ends of the main coupling portion in the X-axis direction.

When a high-frequency signal is input to the hollow waveguide 40, the high-frequency signal input excites the slot 22s. Because the longitudinal direction (Y-axis direction) of the slot 22s intersects the longitudinal direction (extending direction) of the strip conductors 30a, 30b, 31a, and 31b, the slot 22s excited and the strip conductors 30a, 30b, 31a, and 31b are magnetically coupled to each other. Then, the high-frequency signal is output from the input/output ends 20Ha, 20Hb, 20Hc, and 20Hd of the microstrip line via the parallel plate line. As in the case of the first embodiment, the tip portions of the open stubs 24a to 24f and 25a to 25f are each in an electrically open state, so that the base portion of each of the open stubs 24a to 24f and 25a to 25f is equivalently in an electrical short-circuit state. Therefore, the high-frequency signal is shielded at the connecting portions of the coupling conductor 23c with the open stub groups 24 and 25, that is, the first and second coupling end portions. Therefore, unnecessary radiation can be suppressed.

Conversely, when high-frequency signals are each input to the input/output ends 20Ha, 20Hb, 20Hc, and 20Hd of the planar waveguide structure 20H, the high-frequency signals are synthesized and then output from the input/output end 40a of the hollow waveguide 40.

As described above, the planar waveguide structure 20H of the ninth embodiment includes the four input/output ends 20Ha, 20Hb, 20Hc, and 20Hd, so that the hollow-waveguide-to-planar-waveguide transition circuit 9 can be achieved also having a function of a multi-distributor.

Although the various embodiments according to the present invention have been described with reference to the drawings, these embodiments are examples of the present invention, and various forms other than these embodiments can be adopted. For example, in the first to ninth embodiments, the number of open stubs 24a to 24f and 25a to 25f is twelve The number is not limited to twelve. By reducing the number of open stubs from twelve, the hollow-waveguide-to-planar-waveguide transition circuit can be downsized. In addition, by increasing the number of open stubs more than twelve, further improvement can be achieved of the suppression effect of unnecessary radiation, and further improvement can be achieved of the inhibitory effect of the deviation in the distribution characteristic due to the manufacturing error, or the like.

In addition, an open stub group having the same configuration as the open stub groups 24 and 25 may be arranged near the four corners on the front surface of the dielectric substrate 21. As a result, an effect of power loss reduction can be obtained.

Within the scope of the present invention, an arbitrary combination of the first to ninth embodiments, modification of any component of each embodiment, or omission of any component in each embodiment is possible.

### INDUSTRIAL APPLICABILITY

Because the hollow-waveguide-to-planar-waveguide transition circuit according to the present invention is used in a high-frequency transmission line for transmitting a high-frequency signal such as a millimeter wave or a microwave, it is suitable for use in an antenna device, radar device and communication device which operate in a high-frequency band such as a millimeter wave band or a microwave band, for example.

### REFERENCE SIGNS LIST

1 to 9: Hollow-waveguide-to-planar-waveguide transition circuits; 20, 20A to 20H: Planar waveguide structures; 20a, 20b: Input/output ends; 21: Dielectric substrate; 22, 22C, 22G: Ground conductors; 22s: Slot; 23, 23A, 23B, 23E, 23F, 23H: Conductor patterns; 23a, 23b: Strip conductors; 23c: Coupling conductor; 23ca: First coupling conductor; 23cb: Connecting portion; 23cc: Second coupling conductor; 23g, 23h: Recessed portions; 24, 25: Open stub groups; 24a to 24f, 25a to 25f: Open stubs; 26a, 26b: Impedance adjusting portions; 27a, 27b: Notched portions; 30a, 30b, 31a, 31b: Strip conductors; 40: Hollow waveguide; 40a: Input/output end; and SP: Short plane (short-circuit plane).

1. A hollow-waveguide-to-planar-waveguide transition circuit for transmitting a high-frequency signal, the hollow-waveguide-to-planar-waveguide transition circuit comprising:
a dielectric substrate having a first main surface and a second main surface which face each other in a thickness direction of the dielectric substrate;
one or more strip conductors formed on the first main surface, extending along a first in-plane direction determined in advance;
a ground conductor formed on the second main surface to face the one or more strip conductors in the thickness direction;
one or more slots formed in the ground conductor and extending in a second in-plane direction different from the first in-plane direction on the second main surface;
a coupling conductor formed at a position to be electrically coupled with the one or more strip conductors on the first main surface, and disposed at a position facing the one or more slots in the thickness direction; and
one or more branch conductor lines branching from an end portion of the coupling conductor in the second in-plane direction on the first main surface, each of the branch conductor lines having a base portion branching from the coupling conductor and having a tip portion that is an electrically open.

2. The hollow-waveguide-to-planar-waveguide transition circuit according to claim 1, wherein a length of each of the one or more branch conductor lines in a longitudinal direction thereof is equal to a quarter of a wavelength corresponding to a center frequency of a predetermined frequency band for use in the high-frequency signal.

3. The hollow-waveguide-to-planar-waveguide transition circuit according to claim 2, wherein the base portion of each of the one or more branch conductor lines is equivalently in an electrical short-circuit state with respect to the center frequency.

4. The hollow-waveguide-to-planar-waveguide transition circuit according to claim 2, wherein a width of each of the one or more branch conductor lines is equal to or less than one-tenth of the wavelength.

5. The hollow-waveguide-to-planar-waveguide transition circuit according to claim 1, wherein the branch conductor lines are arranged around a periphery of both end portions of each of the one or more slots in a longitudinal direction of said each of the one or more slots as viewed from the thickness direction.

6. The hollow-waveguide-to-planar-waveguide transition circuit according to claim 1, wherein at least one of the branch conductor lines has a bent shape.

7. The hollow-waveguide-to-planar-waveguide transition circuit according to claim 1, wherein the coupling conductor includes:
a main coupling portion connected to the one or more strip conductors; and
a coupling end portion connected to the base portion of each of the one or more branch conductor lines, wherein
a width of the coupling end portion in the first in-plane direction is narrower than a width of the main coupling portion in the first in-plane direction.

8. The hollow-waveguide-to-planar-waveguide transition circuit according to claim 7, wherein the coupling end portion includes a notched portion to form the width of the coupling end portion.

9. The hollow-waveguide-to-planar-waveguide transition circuit according to claim 8, wherein the coupling conductor has a stair shape in which a width of the coupling conductor in the first in-plane direction changes in a manner that stepwise increases the width of the coupling conductor as a location of the width of the coupling conductor changes from the coupling end portion toward the one or more strip conductors.

10. The hollow-waveguide-to-planar-waveguide transition circuit according to claim 8, wherein the coupling conductor has a tapered shape in which a width of the coupling conductor in the first in-plane direction changes in a manner that increases the width of the coupling conductor as a location of the width of the coupling conductor changes from the coupling end portion toward the one or more strip conductors.

11. The hollow-waveguide-to-planar-waveguide transition circuit according to claim 1, further comprising a hollow waveguide having one end portion connected to a region containing the one or more slots in the ground conductor.

12. The hollow-waveguide-to-planar-waveguide transition circuit according to claim 11, wherein a guide-axis direction of the hollow waveguide and the second main surface are orthogonal to each other.

13. The hollow-waveguide-to-planar-waveguide transition circuit according to claim 1, wherein the coupling conductor is physically connected to the one or more strip conductors.

14. The hollow-waveguide-to-planar-waveguide transition circuit according to claim 1, wherein the coupling conductor is disposed physically away from the one or more strip conductors.

15. The hollow-waveguide-to-planar-waveguide transition circuit according to claim 14, wherein:
the strip conductors include a first strip conductor and a second strip conductor which are arranged separately from each other; and
the coupling conductor includes a first recessed portion that surrounds an end portion of the first strip conductor facing the coupling conductor, and includes a second recessed portion that surrounds an end portion of the second strip conductor facing the coupling conductor.

16. The hollow-waveguide-to-planar-waveguide transition circuit according to claim 1, wherein both end portions of each of the one or more slots have respective widths larger than a width of a midportion of said each of the one or more slots.
